(19) United States
(12) Patent Application Publication
(10) Pub. No.: US 2008/0220224 A1
(43) Pub. Date: Sep. 11, 2008

(54) Decorative Material

(76) Inventors: Naoki Tokumoto, Kashiwa-shi (JP); Hideaki Mori, Kashiwa-shi (JP)

Correspondence Address: ST. ONGE STEWARD JOHNSTON & REENS, LLC, 986 BEDFORD STREET, STAMFORD, CT, 06905-5619, US

(21) Appl. No.: 12/041,314

(22) Filed: Mar. 3, 2008

(30) Foreign Application Priority Data
Mar. 6, 2007 (JP) P2007-055424
Dec. 6, 2007 (JP) P2007-315759

(51) Int. Cl. B44F 5/00

(52) U.S. Cl. 428/195.1

(57) ABSTRACT

A decorative material including a pattern layer formed from an aqueous composition, which can be easily handled without receiving any scratches on the surface upon loading or unloading, allows no possibility of load collapse when stacked, and has durable surface staining resistance. The decorative material includes a substrate, a sealer layer containing an aqueous adhesive on the substrate, a pattern layer formed from an aqueous ink on top of the sealer layer, and a surface protective layer covering the pattern layer to form an outermost surface, wherein the surface protective layer includes an antifouling agent containing a silicone oil in a matrix resin formed by curing of an oily resin or an ionizing radiation curable monomer, and the outermost surface has a dynamic coefficient of friction of 0.1 to 0.3.

### CROSS-REFERENCE TO RELATED APPLICATIONS

The present application claims priority of Japanese patent applications Nos. 2007-055424 filed on Mar. 6, 2007 and 2007-315759 filed on Dec. 6, 2007. All prior applications are herein incorporated by reference.

### FIELD OF THE INVENTION

The present invention relates to a decorative material, and more specifically, to a flat or three-dimensional pattern decorative material used for, for example, knockdown ready-to-assemble furniture, general interior materials, and the like.

### BACKGROUND OF THE INVENTION

In the past, a decorative material used for house building materials and furniture, for example, knockdown ready-to-assemble furniture, is provided with a surface protective layer for imparting high gloss. Such a surface protective layer has a low dynamic coefficient of friction, and thus, is likely to slip. In particular, if a silicone oil or the like is added to the layer to provide interlayer adhesiveness and antifouling properties, the dynamic coefficient of friction is further lowered. For this reason, if the layers are laminated on a wood substrate and then processed into a decorative laminate, and many sheets are stacked for delivery or storage, the sheets are likely to slip and collapse, thus being difficult in handling.

Therefore, there has been suggested a decorative material including a substrate, a print layer, a sealer layer, and a top coat layer, wherein the top coat layer includes a cross-linkable resin and the dynamic coefficient of friction is controlled to be in a range from 0.3 to 0.6 (see, for example, JP-A No. 2006-137195). With respect to this decorative material, it is believed that by setting the dynamic coefficient of friction to be in the above-mentioned range, slipping and falling of the sheets can be prevented when a plurality of sheets is stacked.

However, the decorative material in JP-A No. 2006-137195 has problems that if it is formed into a decorative laminate and the dynamic coefficient of friction is set to be in the above-mentioned range, a large force is required to load or unload the decorative laminates, and that surfaces are readily scratched by rubbing against each other.

As the decorative material, a material has been demanded that has more excellent surface staining resistance which is maintained over a longer period of time.

The present invention has been made under these circumstances, and is intended to provide a decorative material including a pattern layer, which can be easily handled without receiving any scratches on the surface upon loading or unloading, gives no possibility of load collapse when stacked, and has durable surface staining resistance.

### SUMMARY OF THE INVENTION

In order to achieve the above objects, the present invention provides the following means.

A decorative material according to an aspect of the present invention includes a substrate; a sealer layer containing an aqueous adhesive, which is provided on the substrate; a pattern layer formed from an aqueous ink, which is provided on top of the sealer layer; and a surface protective layer covering the pattern layer to form an outermost surface, wherein the surface protective layer includes an antifouling agent containing a silicone oil in a matrix resin which is formed by curing an oily resin or an ionizing radiation curable monomer, and the outermost surface has a dynamic coefficient of friction of 0.1 to 0.3.

According to the decorative material of this aspect of the invention, since the dynamic friction coefficient of the outermost surface of the surface protective layer is set in the range of 0.1 to 0.3, decorative laminates formed from the material do not collapse due to friction between the sheets upon stacking, and may be easily handled without receiving scratches on the surface upon unloading. In addition, the material may be provided with a durable surface staining resistance by incorporating a silicone oil in the surface protective layer.

In the decorative material, it is preferable that a concavoconvex pattern is formed on the outermost surface of the surface protective layer.

According to the above-mentioned decorative material of the present invention, a wood tracheary pattern or the like may be expressed by a concavoconvex pattern.

Further, in the decorative material mentioned above, it is preferable that a primer layer containing an aqueous adhesive is interposed between the surface protective layer and the pattern layer.

According to the decorative material of this aspect of the invention, it becomes possible to improve interlayer adhesiveness between the surface protective layer and the pattern layer.

Also, a decorative material according to another aspect of the invention includes a substrate; a pattern layer containing an oil based ink, provided on the substrate; and a surface protective layer covering the pattern layer to form an outermost surface, wherein the surface protective layer comprises an antifouling agent containing a silicone oil in a matrix resin formed by curing of an ionizing radiation curable monomer, and the outermost surface has a dynamic coefficient of friction of 0.1 to 0.3.

According to the decorative material of this aspect of the invention, since the dynamic friction coefficient of the outermost surface of the surface protective layer is set in the range of 0.1 to 0.3, decorative laminates formed from the material do not collapse due to friction between the sheets upon stacking, and may be easily handled without receiving scratches on the surface upon unloading. In addition, the material may be provided with a durable surface staining resistance by incorporating a silicone oil in the surface protective layer.

Further, in the decorative material mentioned above, it is preferable that a primer layer containing an oil based adhesive is interposed between the surface protective layer and the pattern layer.

According to the decorative material of this aspect of the invention, it becomes possible to improve interlayer adhesiveness between the surface protective layer and the pattern layer.

As to the decorative material of the present invention, since the decorative material includes a surface protective layer, the material may be easily handled without receiving any scratches on the surface upon loading or unloading, gives no possibility of load collapse when stacked, and has durable surface staining resistance.

The decorative material of the present invention may be of a flat or three-dimensional pattern, and it may be used for, for example, knockdown ready-to-assemble furniture, general interior materials, and the like.

### BRIEF DESCRIPTION OF THE DRAWINGS

Some of the features and advantages of the invention have been described, and others will become apparent from the detailed description which follows and from the accompanying drawings, in which:

FIG. 1 is a cross-sectional view illustrating a decorative paper of a first embodiment of the present invention;

FIG. 2 is a cross-sectional view illustrating a decorative paper of a second embodiment of the present invention;

FIG. 3 is a cross-sectional view illustrating a decorative paper of a third embodiment of the present invention;

FIG. 4 is a cross-sectional view illustrating a decorative paper of a fourth embodiment of the present invention;

FIG. 5 is a cross-sectional view illustrating a decorative paper of a fifth embodiment of the present invention;

FIG. 6 is a cross-sectional view illustrating a decorative paper of a sixth embodiment of the present invention;

FIG. 7 is a cross-sectional view illustrating a decorative paper of a seventh embodiment of the present invention; and

FIG. 8 is a cross-sectional view illustrating a decorative paper of an eighth embodiment of the present invention.

### DETAILED DESCRIPTION OF THE INVENTION

The invention summarized above and defined by the enumerated claims may be better understood by referring to the following detailed description, which should be read with reference to the accompanying drawings. This detailed description of a particular preferred embodiments, set out below to enable one to build and use one particular implementation of the invention, is not intended to limit the enumerated claims, but to serve as a particular example of the invention.

### First Embodiment

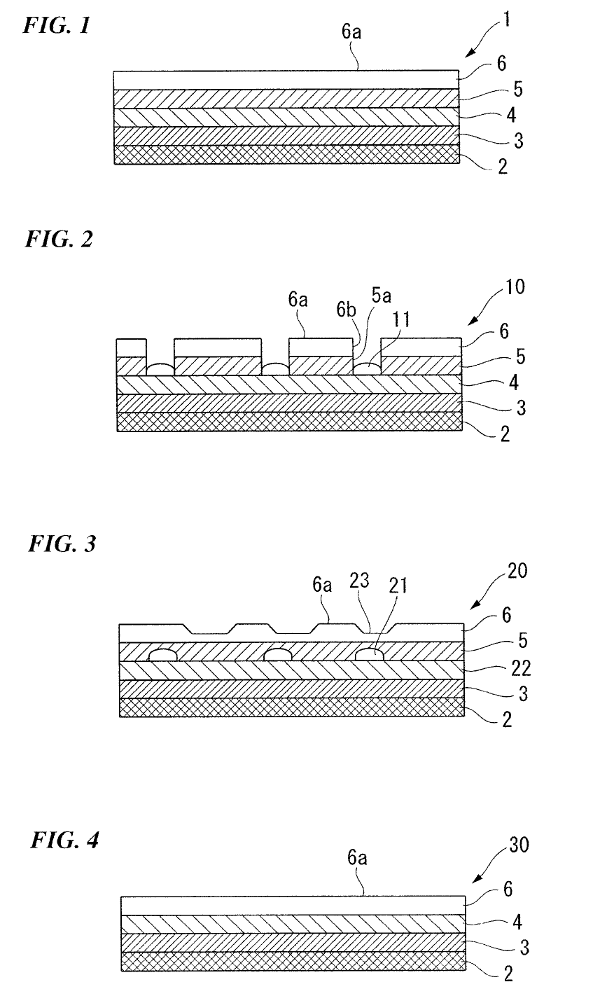

FIG. 1 shows a first embodiment according to the present invention.

As shown in FIG. 1, the decorative paper (decorative material) 1 of the present embodiment includes a substrate 2 made of paper, a sealer layer 3 provided on the substrate 2, a pattern layer 4 formed from an aqueous ink which is provided on the sealer layer 3, a primer layer 5 provided on the pattern layer 4, and a surface protective layer 6 provided on the primer layer 5 to form an outermost surface 6a. Hereinafter, the details of each constitution are described below.

The substrate 2 is not particularly limited as long as it is a material that has been generally used as a substrate of a decorative paper. Specifically, as the substrate, a thin paper, an inter-paper reinforcement paper, an impregnated paper, or the like, can be used. In particular, thin paper such as bleached or non-bleached thin paper and inter-paper reinforcement paper, having a basis weight of 20 to 60 g/m², or impregnated paper having a basis weight of 50 to 250 g/m² can be suitably used.

In the present embodiment, as the decorative material, there mentions only a decorative paper in which paper is used as a substrate, but it is not intended to limit the invention. Thus, materials other than the paper may also be used as a substrate. Examples thereof may include woven or nonwoven fabrics formed of natural fibers or synthetic fibers; a synthetic resin-based substrate including a polyolefin-based resin such as a homo-or random polypropylene resin and a polyethylene resin, a copolymerized polyester resin, a crystalline polyester resin in an amorphous state, a polyethylene naphthalate resin, a polybutylene resin, an acryl-base resin such as a methyl methacrylate resin and a polymethyl methacrylate resin, a styrene-based resin, a polyamide-based resin, a cellulose-based resin, a polycarbonate resin, a polyvinyl chloride resin, a polyvinylidene chloride resin, and a fluorinated resin; a wood-based substrate such as a wood veneer, a sliced veneer, a plywood, a laminated wood, a particle board, and a medium-density fiberboard; an inorganic substrate such as a gypsum plate, a cement plate, a calcium silicate plate, and a ceramic plate; a metallic substrate such as iron, copper, aluminum, and stainless steel; a composite or laminate thereof; and any other conventionally known materials. The shape of the substrate is not particularly limited, and it may be in any form of a film, a sheet, a plate, profile molded products, and the like.

The sealer layer 3 provided on the substrate 2 is an adhesive layer containing an aqueous adhesive, which improves interlayer adhesiveness between the substrate 2 and the pattern layer 4. It is preferably applied in the dry amount of 0.5 to 4.0 g/m². As the aqueous adhesive that forms the sealer layer 3, an aqueous adhesive that contains a binder resin in the form of an aqueous solution or an aqueous emulsion is selected. As the binder resin, for example, a resin such as a (meth)acrylic resin, a urethane resin, casein, an epoxy resin, an alkyd resin, an amino acid-based resin, a polyester resin, a polyvinyl chloride resin, and a cellulose derivative can be selected, as well as an oily resin may also be selected, and the resin may optionally have double bonds.

Furthermore, the binder resin contained in the aqueous adhesive is not necessarily a single resin. That is, a certain binder resin having a double bond may be mixed with one or more other binder resins having or not having a double bond. In this case, the content of the binder resin having a double bond is preferably in a range of 1.0 to 150 mg KOH/g on the average.

Further, the aqueous adhesive may contain one or more monomers having an ethylenically unsaturated double bond which is radically polymerized to be cured by an energy ray such as an ultraviolet ray or an electron beam. When the monomer is contained in an amount such that the content of the resin having a double bond is in the range of 1.0 to 150 mg KOH/g on the average in the binder resin, adhesion properties and staining resistance, particularly the staining resistance can be improved. This further improvement in adhesion property is achieved by the reaction of the monomers contained in the aqueous adhesive with the below-described ionizing radiation curable monomer constituting the surface protective layer 6.

Mixing of these two or more resins is effective for mutual complementarity of properties of the resins. For example, when a mixed resin of a resin which has many double bonds but a high cost and a resin which has no double bond but excellent adhesion properties and a low cost is used, an aqueous adhesive composition having excellent adhesion properties and a satisfactory cost as a whole may be obtained.

When the aqueous binder resin contained in the aqueous adhesive has an acid group, a curing agent may be added to the aqueous adhesive. In this case, as the curing agent, a curing agent having a functional group that has reactivity with the acid group contained in the aqueous binder resin is used. Such curing agent may have, as the functional group, an epoxy group, an oxazoline group, an aziridinyl group, a carbodiimide group, a silanol group, an alkoxylyl group, an amino group, a hydroxyl group, a mercapto group, or the like. One or more of these functional groups can be present in one molecule of a curing agent. The aqueous adhesive containing the curing agent can be cured by heat drying after application.

The amount of the functional group in the curing agent is preferably 0.01 to 0.50 equivalent weight, based on the amount of the acid group in the aqueous binder resin. When the amount of the functional group is less than 0.01 equivalent weight, the effect of incorporation of the curing agent cannot be obtained. When the amount of the functional group is more than 0.50 equivalent weight, the inter-molecular crosslinking of the aqueous binder resin becomes excessive, and the sealer layer 3 becomes rigid. Thus, adhesiveness to an adjacent layer deteriorates, and in an extreme case, insufficient effect of alleviating the strain of the surface protective layer 6 by the aqueous adhesive layer is caused and adhesiveness to the surface protective layer 6 tends to deteriorate. Further, the poor adhesiveness between the layers also leads to deterioration of the staining resistance.

The skeleton of the curing agent is not particularly limited. Examples thereof include skeletons having a relatively low molecular weight, such as pentaerythritol, trimethylolpropane, sorbitol, glycerol, resorcinol, bisphenol, ethylene glycol, polyethylene glycol, and the like.

There are various kinds of curing agents, and thus, a suitable molecular weight thereof cannot be generally defined. However, when the molecular weight is less than about 500, the resulting decorative paper remains sticky and sheets of decorative paper may stick to each other, though it also depends on the addition amount. On the other hand, when the molecular weight is more than 1,000, the amount of the functional group in the curing agent becomes small relative to the acid group in the resin, and sufficient staining resistance may not be obtained, or increase of the viscosity of an aqueous adhesive composition may lead to the same problems caused in the case of a small molecular weight. Therefore, it is preferable that the curing agent has a molecular weight of 500 to 1,000.

The pattern layer 4 provided on the sealer layer 3 may be formed by applying an aqueous picture ink and drying the same. The aqueous picture ink is not particularly limited, as long as it contains an aqueous binder resin and a colorant (e.g., pigment). The aqueous picture ink preferably contains a resin such as a (meth)acrylic resin, casein, a urethane resin, an epoxy resin, an alkyd resin, an amino acid resin, a polyester resin, a polyvinyl chloride resin, a polyethylene glycol, or a cellulose derivative in the form of aqueous solution or aqueous emulsion, as the aqueous binder resin. These binder resins have a property such that they become sparingly soluble in water by going through a drying process after being printed as the aqueous pattern layer. When the binder resin is a water-soluble resin (e.g., a resin having a carboxylic acid group or an amino group), its carboxylic acid group may be neutralized with an amine or the amino group may be neutralized with an acid before use. As the binder resin, (meth)acrylic resins or urethane resins having relatively good properties as a building material are preferable. These aqueous binder resins may or may not have an acid group.

The surface protective layer 6 forming the outermost layer 6a is formed of ionizing radiation curable monomers and an antifouling agent containing a silicone oil. Herein, the ionizing radiation refers to a radiation exerting an ionizing action on a substance, and examples there of include an X-ray, a γ-ray, a β-ray (electron beam), and a shorter wavelength ultraviolet ray. However, a long-wavelength ultraviolet ray is also included in the present invention, since an ultraviolet ray curable resin not exerting an ionizing action may also be used herein as a photopolymerization initiator.

The ionizing radiation curable monomer contained in the surface protective layer 6 is composed only of monomers. That is, the monomer does not include an oligomer (di-or higher-multimer having a molecular weight of less than 10,000) and a polymer (polymer having a molecular weight of 10,000 or more) as a resin forming component.

When the surface protective layer 6 is irradiated with the ionizing radiation as described above, the ionizing radiation curable monomer is cured (cross-linked) to form a matrix resin, and the antifouling agent is incorporated into the matrix resin. The monomer contained in the ionizing radiation curable monomer composition penetrates into underlying layers (e.g., the pattern layer 4, the sealer layer 3, and a primer layer 5), and cures also in the underlying layers by irradiation with ionizing radiation to significantly improve interlayer adhesion strength (anchor effect). Oligomers and polymers generally have high viscosity, but insufficient smoothness and poor anchor effect after application.

Specifically, as the ionizing radiation curable monomer contained in the surface protective layer 6, compounds having an ethylenically unsaturated double bond can be used, and examples thereof include a mono-functional monomer, a bi-functional monomer, and a tri-or more-functional monomer. Usually, the monomer is a non-hydrophilic monomer having no hydrophilicity, and has none of a —CHO group, a —OH group, and a —COOH group.

In the ionizing radiation curable monomer, examples of the mono-functional monomer having an ethylenically unsaturated double bond include 2-(2-ethoxyethoxy)ethyl (meth)acrylate, stearyl (meth)acrylate, tetrahydrofurfuryl (meth)acrylate, lauryl (meth)acrylate, 2-phenoxyethyl (meth)acrylate, isodecyl (meth)acrylate, isooctyl (meth)acrylate, tridecyl (meth)acrylate, caprolactone (meth)acrylate, ethoxylated nonylphenol (meth)acrylate, propoxylated nonylphenol (meth)acrylate, phenoxyethyl (meth)acrylate, phenoxydiethylene (meth)acrylate, ethylene oxide-modified nonylphenyl (meth)acrylate, methoxytriethylene glycol (meth)acrylate, ethylene oxide 2-ethylhexyl (meth)acrylate, isobornyl (meth)acrylate dipropylene glycol (meth)acrylate, and the like.

Further, examples of the bi-functional monomer include 1,3-butanediol di(meth)acrylate, 1,4-butanediol di(meth)acrylate, polyethylene glycol di(meth)acrylate, polypropylene glycol di(meth)acrylate, neopentyl glycol di(meth)acrylate, propoxylated neopentyl glycol di(meth)acrylate, ethoxylated neopentyl glycol di(meth)acrylate, hydroxypivalic acid neopentyl glycol di(meth)acrylate, (hydrogenated) bisphenol A di(meth)acrylate, (hydrogenated) ethylene oxide-modified bisphenol A di(meth)acrylate, (hydrogenated) propylene glycol-modified bisphenol A di(meth)acrylate, 1,6-hexanediol di(meth)acrylate, 2-ethyl-2-butyl-propanediol di(meth)acrylate, 1,9-nonanediol di(meth)acrylate, and the like.

Examples of the poly-functional monomer include tris(2-hydroxyethyl)isocyanurate tri(meth)acrylate, ethoxylated trimethylolpropane tri(meth)acrylate, propoxylated trimethylolpropane tri(meth)acrylate, propoxylated glyceryl tri(meth)acrylate, pentaerythritol tri(meth)acrylate, trimethylolpropane (meth)acrylate, ethylene oxide-modified trimethylolpropane (meth)acrylate, propylene oxide-modified trimethylolpropane (meth)acrylate, tris(acryloxyethyl)isocyanurate, pentaerythritol tetra(meth)acrylate, ditrimethylolpropane tetra(meth)acrylate, ethoxylated pentaerythritol tetra(meth)acrylate, penta(meth)acrylate ester, and dipentaerythritol hexa(meth)acrylate.

As the ionizing radiation curable monomers contained in the surface protective layer 6, monomers such as urethane (meth)acrylate, polyester(meth)acrylate, polyether(meth)acrylate, and polyacryl (meth)acrylate are desirably employed since they have low viscosity, readily provide a smooth surface after application, and enhance an anchor effect on the sealer layer 3, the aqueous pattern layer 4, and the like.

Note that the surface protective layer 6 which forms the outermost surface 6a may be formed by an oily resin and an antifouling agent containing a silicone oil. Examples of the oily resin include two-component urethane resin, denatured acrylic resin, maleate denatured acrylic resin, acrylic polyol, denatured acrylic polyol, polytetramethylene ethylglycol, polyester polyol, alkyd resin, and a mixture thereof. Also, examples of isocyanate which functions as a curing agent include hexamethylene diisocyanate, tolylene diisocyanate, xylene diisocyanate, isophorone diisocyanate, diphenylmethane diisocyanate, and a mixture thereof.

The silicone oil-containing antifouling agent contained in the surface protective layer 6 prevents deposition of stains on the outermost surface 6a of the surface protective layer 6, and allows deposited stains to be readily wiped off with various detergents or solvents. This antifouling agent is incorporated in the matrix resin constituted of the ionizing radiation curable monomers. Therefore, even if removed from the outermost surface 6a of the surface protective layer 6 when stains are wiped off, the silicone oil bleeds out from the inside of the surface protective layer 6 again onto the outermost surface 6a, and thus, staining resistance can be constantly imparted to the outermost surface 6a of the surface protective layer 6. Accordingly, staining resistance can be maintained over a long period of time.

As the silicone oil contained in the antifouling agent, employable oils include a non-modified silicone oil, an amino-modified silicone oil, an epoxy-modified silicone oil, a carboxy-modified silicone oil, a mercapto-modified silicone oil, a carbinol-modified silicone oil, a methacryl-modified silicone oil, and a phenol-modified silicone oil. The amount of the silicone oil is preferably 0.2 to 4.0% by weight, based on the total weight of ionizing radiation curable monomers. When the amount of the silicone oil is less than 0.2% by weight, the addition effect is not obtained. On the other hand, when the amount is more than 4.0% by weight, the silicone oil is present in a large amount on the surface of an aqueous resin underlying layer such as the pattern layer 4 and the sealer layer 3, which results in repelling the underlying aqueous resin, possibly becoming the cause of poor adhesiveness to the surface protective layer 6.

The surface protective layer 6 may contain acicular silica, transparent silica, organic or inorganic silica gel particles, (meth)acrylic resin beads, urethane resin beads, urea formaldehyde resin powders, or the like, having a particulate diameter of 4 to 15 μm, in order to further improve wear resistance. Usually, these particulate additives may be used in an amount of 0.5 to 20.0% by weight, based on the total weight of the ionizing radiation curable monomers. These additives do not lower transparency, adhesiveness, or staining resistance.

Furthermore, to the surface protective layer 6, a mixture of the ionizing radiation curable monomer, and the antifouling agent, with a solvent having a hydroxyl group in the molecule may be applied, and then irradiated with an ionizing radiation to introduce the hydroxyl group into the resultant matrix resin molecule. Thus, the ionizing radiation curable monomer contained in the surface protective layer 6 usually has no hydrophilicity as described above, but the resin molecule formed by curing the ionizing radiation curable monomer comes to have hydrophilicity. As such, by improving wettablility of the surface protective layer 6 containing the ionizing radiation curable monomer and the underlying layers (e.g., the pattern layer 4 formed of the aqueous resin composition, the sealer layer 3, and the like), adhesion properties may be improved. Examples of the solvent having a hydroxyl group in the molecule include water; lower alcohols such as methanol, ethanol, n-butanol, and 2-propanol; and the like. The amount of the solvent added is preferably 3 to 20 parts by weight, based on 100 parts by weight of the ionizing radiation curable monomer.

Furthermore, the surface protective layer 6 is preferably applied in a dry amount of usually 1 to 50 g/m², preferably 1 to 25 g/m², and optimally 7 g/m², although the amount may vary depending on the specific gravity of the resulting matrix resin. In addition, the outermost surface 6a of the surface protective layer 6 is set a dynamic coefficient of friction of 0.1 to 0.3.

The dynamic coefficient of friction is a value evaluated using SLIP/PEEL TESTER Model SP-2000 (manufactured by IMASS. INC.). Specifically, a sample is wound on a weight covered with a foamed urethane rubber having a thickness of 3 mm on a metallic weight of 200 g having a dimension of width of 62.5 mm×length of 62.5 mm, and loaded on the outermost surface 6a of the decorative laminate having the decorative paper 1 adhered thereon, and thus, the dynamic coefficient of friction is measured from a stress when the laminate is moved at a rate of 1270 mm/min.

The primer layer 5 interposed between the pattern layer 4 and the surface protective layer 6 is an adhesive layer that improves the interlayer adhesion property. The primer layer 5 is preferably formed of an aqueous adhesive including a binder resin containing a (meth)acrylic resin as a main component (that constitutes 50% by weight or more based on the total weight of the binder resin) in order to prevent strain caused by shrinkage during curing of the surface protective layer 6. The aqueous adhesive contains the binder resin in the form of an aqueous solution or an aqueous emulsion. Examples of the binder resin that can be incorporated in the aqueous adhesive together with the (meth)acrylic resin, include resins such as an urethane resin, casein, an epoxy resin, an alkyd resin, an amino acid-based resin, a polyester resin, a polyvinyl chloride resin, a cellulose derivative, and the like. Among these, a urethane resin is preferable. Apart from the descriptions above, the aqueous adhesive forming the primer layer 5 is the same as the above-mentioned aqueous adhesive providing the sealer layer 3, and therefore, descriptions thereof (presence of a double bond, its content, a monomer having ethylenically unsaturated double bond, and the amount of double bond, a curing agent, and the like) are omitted. Further, the primer layer 5 is preferably applied in a dry amount of about 0.5 to 10.0 g/m².

### Second Embodiment

FIG. 2 shows a second embodiment according to the present invention. In this embodiment, the same members as in the previous embodiment are represented by the same reference numerals, and descriptions thereof are omitted.

As shown in FIG. 2, the decorative paper 10 of this embodiment has the same layer structure as the decorative paper 1 of the first embodiment, except that a concavoconvex pattern expressed by the concave portions 6b and 5a is formed on the surface protective layer 6 and the primer layer 5. The concavoconvex pattern is given by an aqueous liquid repellent resin composition 11 provided in the form of a pattern on the pattern layer 4, and when the pattern layer 4 is exposed in the form of a pattern through the aqueous liquid-repellent resin composition 11, a wood tracheary pattern can be expressed.

More specifically, the aqueous liquid-repellent resin composition 11 includes a liquid repellent agent and an aqueous binder resin in the form of an aqueous solution or an aqueous emulsion. As the aqueous binder resin, an aqueous acrylic resin is preferably contained, and as the liquid repellent agent, an aqueous fluorinated resin is particularly preferably contained. Further, the aqueous liquid-repellent resin composition 11 may include a pigment or a curing agent, if necessary. The concavoconvex pattern is formed by forming the aqueous liquid-repellent resin composition 11 on the pattern layer 4 in a predetermined pattern; applying an aqueous primer composition (aqueous adhesive) that serves to be the primer layer 5; and then applying an ionizing radiation curable monomer composition that serves to be the surface protective layer 6. The primer layer 5 and the surface protective layer 6 are repelled by the liquid repellent agent contained in the portion where the aqueous liquid-repellent resin composition 11 is present, and laminated selectively on the pattern layer 4 where the aqueous liquid-repellent resin composition 11 is not present. Accordingly, in the surface protective layer 6 and the primer layer 5, the concave portions 6b and 5a are formed in the positions corresponding to the aqueous liquid-repellent resin composition 11, thereby expressing a wood tracheary pattern, etc.

Further, it is also possible that the surface protective layer 6 is matte finished on the whole surface with a grain pattern or an abstract pattern, and then a pattern such as trachea is printed. The tracheary pattern may be visualized by a difference in gloss, etc.

### Third Embodiment

FIG. 3 shows a third embodiment according to the present invention. In this embodiment, the same members as in the previous embodiment are represented by the same reference numerals, and descriptions thereof are omitted.

As shown in FIG. 3, in the decorative paper 20 of the present embodiment, the pattern layer 21 is formed in the form of a pattern. Further, an opacifying layer 22 is interposed between the pattern layer 21 and the sealer layer 3. Further, in the opacifying layer 22, the primer layer 5 is formed to cover the pattern layer 21, thereby forming the surface protective layer 6. A concave portion 23 is formed on the outermost surface 6a of the surface protective layer 6 by embossing processing, thus to form a concavoconvex pattern, thereby expressing a wood tracheary pattern, etc.

The pattern layer 21 has the same structure as the pattern layer 4 of the decorative paper 1 of the first embodiment, except that it is formed in the form of a pattern. Further, the opacifying layer 22 is formed of an aqueous opacifying ink including an opacifying pigment and a binder resin. As the opacifying pigment, titanium oxide, iron oxide, carbon black, or the like may be used. As the binder resin, an aqueous urethane resin, aqueous acrylic resin, casein, or the like may be used. These resins are contained in the form of an aqueous solution or an aqueous emulsion in an aqueous opacifying ink.

### Fourth Embodiment

FIG. 4 shows a fourth embodiment according to the present invention. In this embodiment, the same members as in the previous embodiment are represented by the same reference numerals, and descriptions thereof are omitted.

As shown in FIG. 4, the decorative paper 30 of the present embodiment has the same structure as the decorative paper 10 of the first embodiment, except that the primer layer 5 is not provided. Although the primer layer 5 is not provided as in decorative paper 30 according the present embodiment, adhesiveness between the surface protective layer 6 and the pattern layer 4 is significantly high owing to the anchor effect provided by the ionizing radiation curable monomer constituting the surface protective layer 6.

### Fifth Embodiment

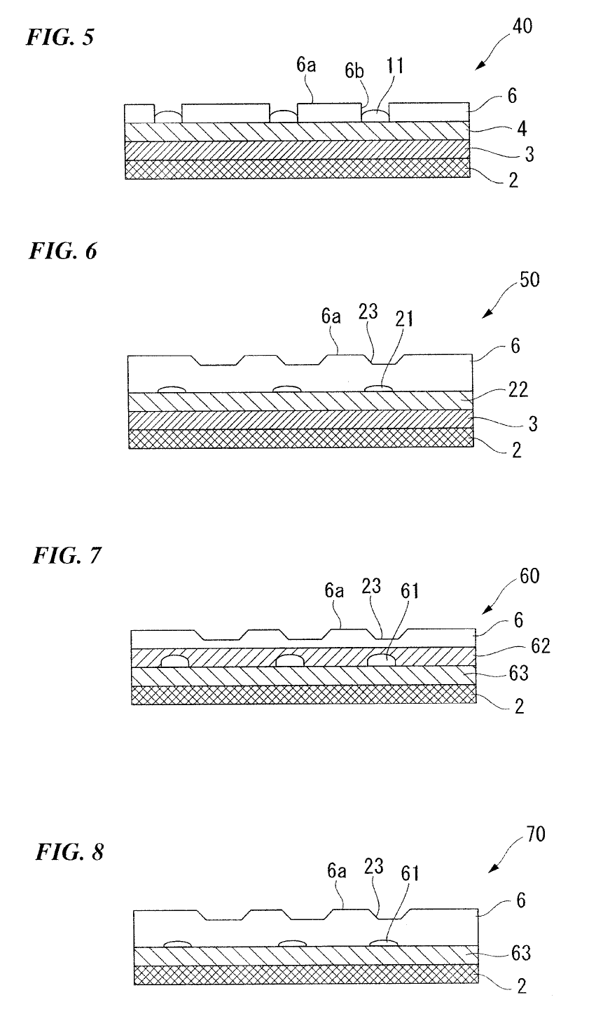

FIG. 5 shows a fifth embodiment according to the present invention. In this embodiment, the same members as in the previous embodiment are represented by the same reference numerals, and descriptions thereof are omitted.

As shown in FIG. 5, the decorative paper 40 of the present embodiment has the same structure as the decorative paper 10 of the second embodiment, except that the primer layer 5 is not provided. Similarly, in this case, adhesiveness between the surface protective layer 6 and the pattern layer 4 is significantly high owing to the anchor effect provided by the ionizing radiation curable monomer constituting the surface protective layer 6.

### Sixth Embodiment

FIG. 6 shows a sixth embodiment according to the present invention. In this embodiment, the same members as in the previous embodiment are represented by the same reference numerals, and descriptions thereof are omitted.

As shown in FIG. 6, the decorative paper 50 of the present embodiment has the same structure as the decorative paper 20 of the third embodiment, except that the primer layer 5 is not provided. Similarly, in this case, adhesiveness between the surface protective layer 6, the pattern layer 21, and the opacifying layer 22 is significantly high owing to the anchor effect provided by the ionizing radiation curable monomer constituting the surface protective layer 6.

### Seventh Embodiment

FIG. 7 shows a seventh embodiment according to the present invention. In this embodiment, the same members as in the previous embodiment are represented by the same reference numerals, and descriptions thereof are omitted.

As shown in FIG. 7, the decorative paper 60 of the present embodiment has the same structure as the decorative paper 20 of the third embodiment, except that no sealer layer is provided. Similarly, in the decorative paper 60 of this embodiment, an oil based ink and an oil based adhesive are used as the pattern layer 61, and an oil based adhesive is used as the primer layer 62. Also, an opacifying layer 63 is formed of an oil based opacifying ink including an opacifying pigment and an oily binder resin.

Examples of the oily binder resin when oil based ink is used for the pattern layer 61 include those in which nitrocellulose, urethane resin, acrylic resin, alkyd resin, polyester resin, polyvinyl chloride resin, butyral resin, etc. is used singularly or in a mixture together with oily solvent. Examples of the oily solvent include ethyl acetate, butyl acetate, methylethylketone, methanol, ethanol, isopropyl alcohol, acetone, methylisobutylketone, polyethylene glycol monomethylether, polyethylene glycol monoethylether, and a mixture thereof.

Also, examples of the oil based adhesive used for the primer layer 62 include polyester polyol with various isocyanate, acrylic oligomer with various isocyanate, acrylic polyol with various isocyanate, and a mixture of acrylic oligomer and acrylic polyol with various isocyanate.

Examples of the above-mentioned various isocyanate include hexamethylene diisocyanate, tolylene diisocyanate, xylene diisocyanate, isophorone diisocyanate, diphenylmethane diisocyanate, and a mixture thereof.

Examples of the opacifying pigment used for the an opacifying layer 63 include titanium oxide, iron oxide, and carbon black. Also, examples of the oily binder resin include those for the pattern layer 61.

In the decorative sheet 60 in which oil based ink is used as the pattern layer 61, interlayer adhesiveness may be improved, without a presence of a sealer layer, by providing the primer layer 62 formed of an oil based adhesive. Also, by setting the dynamic friction coefficient of the outermost surface 6a, it becomes possible to provide a suitable slippage property, and to improve loading property.

### Eighth Embodiment

FIG. 8 shows an eighth embodiment according to the present invention. In this embodiment, the same members as in the previous embodiment are represented by the same reference numerals, and descriptions thereof are omitted.

As shown in FIG. 8, the decorative paper 70 of the present embodiment has the same structure as the decorative paper 60 of the seventh embodiment, except that the primer layer 62 is not provided. In this case, adhesiveness between the surface protective layer 6, the pattern layer 21, and the opacifying layer 22 is also significantly high owing to the anchor effect provided by the ionizing radiation curable monomer constituting the surface protective layer 6.

Hereinafter, each of the decorative papers 1, 10, 20, 30, 40, 50, 60 and 70 of the first to eighth embodiments will be described in detail with reference to Examples 1 to 10 below.

### EXAMPLE 1

In the present Example, a decorative paper 1 of the first embodiment as shown in FIG. 1 was prepared as follows.

Specifically, on the surface of inter-paper reinforcement paper having a basis weight of 30 g/m² (A20C, manufactured by Tentok Paper Co., Ltd.) which served as a substrate 2, an aqueous urethane resin-based paint having reactive groups (LW 059 Sealer, manufactured by Toyo Ink Mfg. Co., Ltd.) was applied so as to provide a dry amount of 1.0 g/m² thereby forming a sealer layer 3.

On this sealer layer 3, a wood grain pattern was gravure-printed by using an aqueous picture ink including 50 parts by weight of an aqueous acrylic resin binder (manufactured by Toyo Ink Mfg. Co., Ltd.; solid content: 25% by weight, acid value: 150 mg KOH/g), 1 part by weight of an aqueous resin having an oxazoline ring as a curing agent (solid content: 40% by weight, functional group value: 252 mg KOH/g), 5 parts by weight of an ink (PCW, manufactured by Toyo Ink Mfg. Co., Ltd.; composed of a disazo-based red pigment, a disazo-based yellow pigment, and a phthalocyanine-based indigo blue pigment), and 44 parts by weight of water, given a total of 100 parts by weight. Thus, a pattern layer 4 was formed.

A mixture (Primer-A, manufactured by Liochem, Inc.) of an aqueous acrylic resin emulsion (solid content: 40% by weight) and an aqueous urethane resin emulsion (urethane resin emulsion having a double bond; solid content: 40% by weight) at a weight ratio of 7:3 was diluted with water, and applied on the pattern layer 4 to give a primer layer 5 with the dry amount of 2 g/m².

On this primer layer 5, a mixture of ionizing radiation curable monomers (50 parts by weight of pentaerythritol tri(meth)acrylate and 50 parts by weight of ethoxylated trimethylolpropane (meth)acrylate), 0.5 part by weight of an amino-modified silicone oil, and 5.0 parts by weight of transparent acicular silica having a particle diameter of 10 μm was coated in an amount of 10 g/m². Then, the coating was cured by irradiation with an electron beam under a nitrogen atmosphere to form a surface protective layer 6. The irradiation conditions were as follows: a dose of 50 KGy (5 Mrad), 125 V, and a line speed of 200 m/min.

In the decorative paper 1 thus prepared, the dynamic coefficient of friction of the outermost surface 6a of the surface protective layer 6 was 0.150, as measured by the above-described method.

### EXAMPLE 2

In the present Example, the decorative paper 10 of the second embodiment as shown in FIG. 2 was prepared in the following manner. The details of the substrate 2, the sealer layer 3, the pattern layer 4, the primer layer 5, and the surface protective layer 6 are the same as in Example 1.

In this Example, an aqueous liquid repellent composition 11 (including 40 parts by weight of an aqueous acrylic resin, 25 parts by weight of an aqueous melamine resin, 30 parts by weight of an aqueous fluorinated resin emulsion, and 5 parts by weight of carbon black, based on 100 parts by total weight of the composition) was formed in a predetermined pattern on the pattern layer 4, and the primer layer 5, the surface protective layer 6 were laminated to form concave portions 6b and 5a, and a tracheary pattern was printed.

In the decorative paper 10 thus prepared, the dynamic coefficient of friction of the outermost surface 6a of the surface protective layer 6 was 0.125, as measured by the above-described method.

### EXAMPLE 3

In the present Example, the decorative paper 20 of the third embodiment as shown in FIG. 3 was prepared as follows. The details of the substrate 2, the sealer layer 3, the primer layer 5, and the surface protective layer 6 are the same as in Example 1.

In the present Example, an aqueous opacifying layer (ink manufactured by Toyo Ink Mfg. Co., Ltd.; composed of a titanium oxide-based white pigment, an iron oxide-based brown pigment, an iron oxide-based khaki pigment, and a carbon black-based black pigment) was gravure-printed on the sealer layer 3 so as to provide a dry amount of 10 g/m² to form an opacifying layer 22. Then, a pattern layer 21 was formed in a predetermined pattern on the opacifying layer 22. Details on the pattern layer 21 are the same as the pattern layer 4 of Example 1, and thus description thereof is omitted here. A primer layer 5 was formed to cover the opacifying layer 22 and the pattern layer 21, and further a surface protective layer 6 was formed. Finally, a concavoconvex pattern was provided by using a concavoconvex roller heated from room temperature to about 100° C. to the outermost surface 6a of the surface protective layer 6 to form a concave portion 23. Further, if it is possible to form the concave portion 23 without heating, it is not necessary to heat the concavoconvex roller.

In the decorative paper 20 thus prepared, the dynamic coefficient of friction of the outermost surface 6a of the surface protective layer 6 was 0.200, as measured by the above-described method.

### EXAMPLE 4

In the present Example, the decorative paper 30 of the fourth embodiment as shown in FIG. 4 was prepared in the same manner as in Example 1, except that the primer layer 5 was not provided.

In the decorative paper 30 thus prepared, the dynamic coefficient of friction of the outermost surface 6a of the surface protective layer 6 was 0.125, as measured by the above-described method.

### EXAMPLE 5

In the present Example, the decorative paper 40 of the fifth embodiment as shown in FIG. 5 was prepared in the same manner as in Example 2, except that the primer layer 5 was not provided.

In the decorative paper 40 thus prepared, the dynamic coefficient of friction of the outermost surface 6a of the surface protective layer 6 was 0.125, as measured by the above-described method.

### EXAMPLE 6

In the present Example, the decorative paper 50 of the sixth embodiment as shown in FIG. 6 was prepared in the same manner as in Example 3, except that the primer layer 5 was not provided.

In the decorative paper 50 thus prepared, the dynamic coefficient of friction of the outermost surface 6a of the surface protective layer 6 was 0.125, as measured by the above-described method.

### EXAMPLE 7

In the present Example, the decorative paper 10 of the first embodiment as shown in FIG. 1 was prepared in the same manner as in Example 1, except that 5.0 parts by weight of water were added to the ionizing radiation curable composition for forming the surface protective layer 6, based on 100 parts by weight of the ionizing radiation curable monomer.

In the decorative paper 10 thus prepared, the dynamic coefficient of friction of the outermost surface 6a of the surface protective layer 6 was 0.125, as measured by the above-described method.

### EXAMPLE 8

In the present Example, the decorative paper 10 of the first embodiment as shown in FIG. 1 was prepared in the same manner as in Example 1, except 5 parts by weight of a curing agent (LT 109 EB Hardener manufactured by Liochem, Inc.) were added to the aqueous urethane resin-based paint for forming the sealer layer 3.

In the decorative paper 10 thus prepared, the dynamic coefficient of friction of the outermost surface 6a of the surface protective layer 6 was 0.125, as measured by the above-described method.

### EXAMPLE 9

In the present Example, a decorative paper 60 of the seventh embodiment as shown in FIG. 7 was prepared as follows.

Specifically, on the surface of inter-paper reinforcement paper having a basis weight of 30 g/m² (A20C, manufactured by Tentok Paper Co., Ltd.) which served as a substrate 2, nitrocellulose type oil-based opacifying ink (a product of Toyo Ink Mfg. Co., Ltd., made of titanium oxide based white pigment, iron oxide based brown pigment, iron oxide based khaki pigment, and carbon black based black pigment) was applied so as to form an opacifying layer 63. Then, on this opacifying layer 63, a wood grain pattern layer 61 was gravure-printed by using an oil based pattern picture ink including disazo based yellow pigment and phthalocyanine based indigo pigment.

An oil-based two-component urethane resin (a 50:50:4 mixture in weight ratio of acryl oligomer, acryl polyol, and hexamethylene diisocyanate curing agent) was diluted with an organic solvent (a 7:3 mixture in weight ratio of ethyl acetate and butyl acetate), i.e., 100 parts by weight of the oil-based two-component urethane resin was diluted with 20 parts by weight of organic solvent, and applied on the pattern layer 61 to give a primer layer 62 with the dry amount of 2 g/m².

On this primer layer 62, a mixture of ionizing radiation curable monomers (50 parts by weight of pentaerythritol tri(meth)acrylate and 50 parts by weight of ethoxylated trimethylolpropane (meth)acrylate), 0.5 part by weight of an amino-modified silicone oil, and 5.0 parts by weight of transparent acicular silica having a particle diameter of 10 μm was coated in an amount of 10 g/m². Then, the coating was cured by irradiation with an electron beam under a nitrogen atmosphere to form a surface protective layer 6. The irradiation conditions were as follows: a dose of 50 KGy (5 Mrad), 125 V, and a line speed of 200 m/min.

In the decorative paper 60 thus prepared, the dynamic coefficient of friction of the outermost surface 6a of the surface protective layer 6 was 0.120, as measured by the above-described method.

### EXAMPLE 10

In the present Example, the decorative paper 70 of the eighth embodiment as shown in FIG. 8 was prepared. The procedure was same as that in Example 9 except that the primer layer 62 was not provided.

In the decorative paper 70 thus prepared, the dynamic coefficient of friction of the outermost surface 6a of the surface protective layer 6 was 0.120, as measured by the above-described method.

Hereinafter, decorative papers according to Comparative Examples 1 to 3 were prepared for the comparison with those according to Examples 1 to 10.

### COMPARATIVE EXAMPLE 1

In the present Comparative Example, a decorative paper was prepared in the same manner as the decorative papers 1 of Example 1, except that in the decorative paper 1 of Example 1, the content of the amino-modified silicone oil contained in the surface protective layer 6 was 4.5% by weight.

In the decorative paper of Comparative Example 1 thus prepared, the dynamic coefficient of friction of the outermost surface 6a of the surface protective layer 6 was 0.09, as measured by the above-described method.

### COMPARATIVE EXAMPLE 2

In the present Comparative Example, a decorative paper was prepared in the same manner as the decorative paper 1 of Example 1, except that in the decorative paper 1 of Example 1, the content of the amino-modified silicone oil contained in the surface protective layer 6 was 0.1% by weight.

In the decorative paper of Comparative Example 2 thus prepared, the dynamic coefficient of friction of the outermost surface 6a of the surface protective layer 6 was 0.37, as measured by the above-described method.

### COMPARATIVE EXAMPLE 3

In the present Comparative Example, a decorative paper was prepared in the same manner as the decorative paper 1 of Example 1, except that in the decorative paper 1 of Example 1, the amino-modified silicone oil was not contained in the surface protective layer 6.

In the decorative paper of Comparative Example 3 thus prepared, the dynamic coefficient of friction of the outermost surface 6a of the surface protective layer 6 was 0.45, as measured by the above-described method.

### Evaluation of Performances

The decorative paper manufactured in Examples 1 to 10, and Comparative Examples 1 to 3 were each adhered to a particle board with an urea-based adhesive to prepare decorative laminates, and each decorative laminate was evaluated on performances such as loadability, adhesion property, and staining resistance. For staining resistance, four items, i.e., acid resistance, alkali resistance, solvent resistance, and dyeing resistance, were evaluated. Hereinbelow, details on the performance of each and a method for evaluating the same are described, and the results are shown in Table 1, together with the measurement results of the dynamic coefficient of friction.

1. Loadability

Each sheet of decorative paper was adhered to a particle board having the dimensions of 25 mm×300 mm×300 mm (thickness×width×length) to prepare 20 sheets of each decorative laminate. The 20 sheets of each decorative laminate of Examples and Comparative Examples were stacked, and all of them were inclined at 5°. Then, their slippage during loading was tested. For evaluation, it was tested whether or not the decorative laminate collapsed, or scratches were formed on the surface of the decorative paper. Here, in the loadability columns of Table 1, ◯ indicates no collapse, and × indicates slippage and collapse, or no slippage but scratches were formed on the surface of the decorative paper.

2. Adhesion

Each sheet of decorative paper was adhered to a particle board having a thickness 5 mm to prepare a decorative laminate. In the decorative laminate according to each of Examples and Comparative Examples, 25 grids having a width of 1 mm cut with a cutter, and cellophane tape (Registered trademark of Nichiban Co., Ltd.) having a width of 25 mm was attached thereon using BEMCOT (manufactured by Asahi Kasei Fibers Corporation), and allowed to stand for 24 hours. Then, the cellophane tape (Registered trademark of Nichiban Co., Ltd.) was pulled at an angle of 45° above the horizontal direction. At this time, when the number of peeled grid pieces was 5 or less, adhesiveness was evaluated as to have passed. Here, in the adhesion columns of Table 1, ⊚ indicates no peeled grid piece, ◯ indicates 1 to 5 peeled grid pieces, and × indicates 6 or more peeled grid pieces.

3. Stain Resistance

Each sheet of decorative paper was adhered onto a particle board having a thickness 5 mm to prepare a decorative laminate. In the decorative laminate according to each of Examples and Comparative Examples, and the surface of the decorative paper of each decorative laminate was observed using the following tests.

a) Acid Resistance

On the decorative paper of each sheet of decorative laminate, absorbent cotton impregnated sufficiently with a 10% citric acid aqueous solution was placed, covered with a watch glass, and allowed to stand for 18 hours. 18 hours later, its surface was wiped with the absorbent cotton. The surface condition was observed, and compared with the non-treated surface.

b) Alkali Resistance

Alkali resistance was evaluated in the same manner as for the acid resistance evaluation by using a 10% ammonia aqueous solution instead of the citric acid aqueous solution.

c) Solvent Resistance

Solvent resistance was evaluated in the same manner as for the acid resistance evaluation by using a mixture of isopropyl alcohol and water at a volume ratio of 70:30 instead of the citric acid aqueous solution.

d) Dyeing Resistance

Dyeing resistance was evaluated in the same manner as for the acid resistance evaluation by using a violet dye ink (alcohol solvent-based) instead of the citric acid aqueous solution.

Regarding acid resistance, alkali resistance, solvent resistance, swelling, peeling, softening, remarkable coloration, and gloss change were each observed during observation of the surface. Here, in each of the columns for the test results in Table 1, ⊚ indicates no occurrence of the phenomena as above, and thus no problem with the appearance, ◯ indicates slight occurrence of the phenomena as above, but no problem with the appearance, Δ indicates slight occurrence of the phenomena as above, and thus there is a problem with the appearance, and × indicates clear occurrence of the phenomena as above, and thus there is a problem with the appearance.

Further, for dyeing resistance, whether or not the color of ink is remained on the surface was observed. Here, in the columns for these test results in Table 1, ⊚ indicates no color remaining on the surface of the decorative paper, and thus no problem with the appearance, ◯ indicates slight color remaining on the surface of decorative paper, but no problem with the appearance, Δ indicates slight color remaining on the surface of decorative sheet, and thus there is a problem with the appearance, and × indicates clear color remaining on the surface of decorative sheet, and thus there is a problem with the appearance.

TABLE 1

| | Exam- | Exam- | Exam- | Exam- | Exam- | Exam- | Exam- | Exam- | Exam- | Exam- | Comparative | Comparative | Com- |
|---|---|---|---|---|---|---|---|---|---|---|---|---|---|
| | ple | ple | ple | ple | ple | ple | ple | ple | ple | ple | Example | Example | parative |
| | 1 | 2 | 3 | 4 | 5 | 6 | 7 | 8 | 9 | 10 | 1 | 2 | Example 3 |
| Loadability | ◯ | ◯ | ◯ | ◯ | ◯ | ◯ | ◯ | ◯ | ◯ | ◯ | X | X | X |
| Dynamic | 0.150 | 0.125 | 0.200 | 0.125 | 0.125 | 0.125 | 0.125 | 0.125 | 0.120 | 0.120 | 0.090 | 0.370 | 0.45 |
| friction | | | | | | | | | | | | | |
| coefficient | | | | | | | | | | | | | |
| Adhesion | ⊚ none | ⊚ none | ◯ 2 | ◯ 3 | ◯ 2 | ◯ 1 | ◯ 1 | ⊚ none | ◯ 1 | ◯ 2 | X 6 | X 6 | X 10 |
| Acid | ◯ | ◯ | ◯ | ◯ | ◯ | ◯ | ◯ | ◯ | ◯ | ◯ | ◯ | ◯ | Δ |
| resistance | | | | | | | | | | | | | |
| Alkali | ◯ | ◯ | ◯ | ◯ | ◯ | ◯ | ◯ | ◯ | ◯ | ◯ | ◯ | ◯ | Δ |
| resistance | | | | | | | | | | | | | |
| Solvent | ◯ | ◯ | ◯ | ◯ | ◯ | ◯ | ◯ | ◯ | ◯ | ◯ | ◯ | ◯ | Δ |
| resistance | | | | | | | | | | | | | |
| Dying | ◯ | ◯ | ◯ | ◯ | ◯ | ◯ | ◯ | ◯ | ◯ | ◯ | ◯ | ◯ | X |
| resistance | | | | | | | | | | | | | |
| Total | Passed | Passed | Passed | Passed | Passed | Passed | Passed | Passed | Passed | Passed | Rejected | Rejected | Rejected |
| evaluation | | | | | | | | | | | | | |

As seen from the results shown in Table 1, satisfactory results of tests on the loadability, adhesion properties, and staining resistance were obtained in Examples 1 to 10.

On the other hand, for Comparative Example 1, in the evaluation on the loadability of the sheets, the sheets slipped and collapsed, and thus loadability was evaluated as unacceptable. This is believed to be attributable to the fact that the dynamic coefficient of friction of the outermost surface 6a of the decorative paper was decreased to 0.090. Further, in the evaluation on adhesiveness, the number of peeled grid pieces was 6 or more, and thus adhesion was evaluated as unacceptable. This is believed to be attributable to the fact that although due to a high content of the silicone oil and thus a reduced dynamic coefficient of friction, the cellophane tape (Registered trademark of Nichiban Co., Ltd.) was easily peeled, but the interlayer adhesion property was drastically lowered, and as a result, delamination between the layers occurred.

Furthermore, for Comparative Example 2, in the evaluation on loadability of the sheets, the sheets slightly collapsed, but scratches on the surface were observed, and thus loadability was evaluated as unacceptable. This is believed to be attributable to the fact that the dynamic coefficient of friction of the outermost surface 6a of the decorative paper was increased to 0.370. Further, in the evaluation on adhesiveness, the number of peeled grid pieces was 6 or more, and thus adhesion was evaluated as unacceptable. This is believed to be attributable to the fact that due to a low content of the silicone oil in the surface protective layer 6 and thus increasing dynamic coefficient of friction, the cellophane tape (Registered trademark of Nichiban Co., Ltd.) was hardly peeled.

Furthermore, for Comparative Example 3, in the evaluation on the loadability of the sheets, most of the sheets did not slip and did not collapsed, but scratches on the surface were observed, and thus loadability was evaluated as unacceptable. This is believed to be attributable to the fact that the dynamic coefficient of friction of the outermost surface 6a of the decorative paper was increased to 0.450. Further, in the evaluation on adhesiveness, the number of peeled grid pieces was 6 or more, and thus adhesion was evaluated as unacceptable. This is believed to be attributable to the fact that due to absence of the silicone oil in the surface protective layer 6 and thus increasing dynamic coefficient of friction, the cellophane tape (Registered trademark of Nichiban Co., Ltd.) was hardly peeled. In addition, in evaluation of staining resistance, staining resistance was evaluated as unacceptable. This is also believed to be attributable to the absence of the silicone oil.

As described above, the decorative paper of the present invention includes the pattern layer 4, 21, or 61 formed from an aqueous composition, and has a laminate of an above-described constitution including the sealer layer 3, the pattern layer 4, 21, or 61 and the surface protective layer 6, laminated on a substrate, wherein the surface protective layer 6 contains an antifouling agent containing a silicone oil in a matrix resin formed by curing of an oily resin or an ionizing radiation curable monomer, and the outermost surface has a dynamic coefficient of friction of 0.1 to 0.3. Accordingly, the decorative paper of the invention can be easily handled without receiving any scratches on the surface upon loading or unloading, gives no possibility of load collapse when stacked, and has durable surface staining resistance.

Having thus described exemplary embodiments of the invention, it will be apparent that various alterations, modifications, and improvements will readily occur to those skilled in the art. Such alterations, modifications, and improvements, though not expressly described above, are nonetheless intended and implied to be within the spirit and scope of the invention. Accordingly, the foregoing discussion is intended to be illustrative only; the invention is limited and defined only by the following claims and equivalents thereto.

What is claimed is:

1. A decorative material comprising:
a substrate;
a sealer layer containing an aqueous adhesive, provided on the substrate;
a pattern layer formed from an aqueous ink, provided on top of the sealer layer, and
a surface protective layer covering the pattern layer to form an outermost surface,
wherein the surface protective layer comprises an antifouling agent containing a silicone oil in a matrix resin formed by curing of an oily resin or an ionizing radiation curable monomer, and the outermost surface has a dynamic coefficient of friction of 0.1 to 0.3.

2. The decorative material according to claim 1, wherein a concavoconvex pattern is formed on the outermost surface of the surface protective layer.

3. The decorative material according to claim 1, wherein a primer layer containing an aqueous adhesive is provided between the surface protective layer and the pattern layer.

4. The decorative material according to claim 2, wherein a primer layer containing an aqueous adhesive is provided between the surface protective layer and the pattern layer.

5. A decorative material comprising:
a substrate;
a pattern layer containing an oil based ink, provided on the substrate; and
a surface protective layer covering the pattern layer to form an outermost surface,
wherein the surface protective layer comprises an antifouling agent containing a silicone oil in a matrix resin formed by curing of an ionizing radiation curable monomer, and the outermost surface has a dynamic coefficient of friction of 0.1 to 0.3.

6. The decorative material according to claim 5, wherein a primer layer containing an oil based adhesive is provided between the surface protective layer and the pattern layer.
